(19) United States
(12) Patent Application Publication
(10) Pub. No.: US 2026/0099184 A1
(43) Pub. Date: Apr. 9, 2026

(54) MONITORING AN ELECTRICAL WIRING CONNECTION CONFIGURATION OF AN ELECTRICAL POWER SYSTEM

(71) Applicant: EATON INTELLIGENT POWER LIMITED, Dublin 4 (IE)

(72) Inventors: Daniel ZUCCHETTO, Dublin (IE); Nathan CUNNINGHAM, Dublin 11 (IE)

(21) Appl. No.: 19/114,097

(22) PCT Filed: Sep. 28, 2022
(86) PCT No.: PCT/EP2022/077074

§ 371 Date: Mar. 21, 2025

(51) Int. Cl. G06F 1/28

(52) U.S. Cl. CPC G06F 1/28; H02J 3/0012; H02J 13/12; H02J 2103/30

(57) ABSTRACT

Some embodiments relate to monitoring an electrical power system including power distribution units (PDUs) and electrical equipment units to be provided with electrical power. The method includes receiving PDU data comprising time series data indicative of power usage of each of the PDU outlets during a first time period; receiving activity data comprising time series data indicative of one or more activity metrics for each of the electrical equipment units during the first time period; and detecting an event indicative of a change of an electrical wiring connection configuration between the outlets of the PDUs and the electrical equipment units during the first time period.

### CROSS-REFERENCE TO RELATED APPLICATIONS

This application is a national phase filing under 35 C.F.R. § 371 of and claims priority to PCT Patent Application No. PCT/EP2022/077074, filed on Sep. 28, 2022, the contents of which are hereby incorporated in their entireties by reference.

### TECHNICAL FIELD

The disclosure relates to monitoring an electrical power system comprising a plurality of power distribution units (PDUs) and a plurality of electrical equipment units to be provided with electrical power. In particular, the disclosure relates to detecting alterations of the electrical wiring connection configuration between power outlets of the PDUs and the electrical equipment units.

### BACKGROUND

Electrical power systems control the delivery of electrical power to individual electrical equipment units or users that require such electrical power. For instance, in a data centre electrical power is delivered to individual units of electrical equipment in a server room, e.g. individual server machines, from power distribution units (PDUs). In particular, electrical power is delivered via electrical wiring connections between outlets of the PDUs and the server machines.

It is desirable to have knowledge of the topology or configuration of the electrical wiring connections linking the PDUs and electrical equipment units, such as servers, i.e. knowledge of which PDU outlets are connected to which electrical equipment units. For instance, this can assist in ensuring that sufficient redundancy is in place for server machines or other equipment that provide critical services, in identifying security breaches, or in understanding the effect of withdrawing or shutting down a particular power line, e.g. for maintenance. Such an electrical wiring configuration can change relatively frequently over time; for instance, when server machines are swapped in and out of service, or when maintenance is to be performed on certain components of the electrical power system.

It is known to perform manual mapping of the topology or configuration of the electrical wiring connections of an electrical power system. That is, the physical wiring links may be inspected manually by service personnel. However, such an approach suffers the drawbacks of being error prone, as well as being relatively slow and expensive to perform. Indeed, a relatively long period of time may elapse between an alteration or change in wiring topology occurring and the change being reflected in records, as the records may only be updated during relatively infrequent updates that are performed manually. This can pose issues where knowledge of the wiring configuration may be time sensitive, such as in the context of unplanned server downtime where a set of PDUs need to be replaced.

It is against this background to which the present disclosure is set.

### SUMMARY OF THE DISCLOSURE

According to an aspect of the disclosure, there is provided a computer-implemented method for monitoring an electrical power system comprising a plurality of power distribution units (PDUs) and a plurality of electrical equipment units to be provided with electrical power. The method comprises: receiving PDU data comprising time series data indicative of power usage of each of the PDU outlets during a first time period; receiving activity data comprising time series data indicative of one or more activity metrics for each of the electrical equipment units during the first time period; detecting an event indicative of a change of an electrical wiring connection configuration between the outlets of the PDUs and the electrical equipment units during the first time period, the event being detected by: determining a first set of associations between the PDU outlets and the electrical equipment units, indicative of the electrical wiring connection configuration during the first time period, based on the received PDU data and activity data (relating to the first time period); and comparing the first set of associations to a reference set of associations to identify an altered association indicative of an altered electrical wiring connection between a respective pair of the PDU outlets and electrical equipment units during the first time period; and upon detecting the event, estimating an alteration point of the electrical wiring connection configuration based, at least in part, on: a determined confidence score relating to the altered association; and one or more end points of the first time period.

In this manner, the method allows for changes or alterations in the wiring configuration—which may occur relatively frequently—to be identified in real time, quasi real time, or at any other desired frequency, and the alteration point can be accurately identified, for example to identify an operator responsible for the change, or to associate the change with subsequent power distribution changes.

It shall be appreciated that the first time period may, for example, correspond to the most recent period of acquired time series data, e.g. for a current analysis period.

Optionally, estimating the alteration point comprises estimating a proportion of the first time period that precedes or succeeds the alteration of the electrical wiring connection based on the determined confidence score. For example, estimating the alteration point may comprise: determining a duration of the first time period; and estimating the alteration point based on: one or more end points of the first time period; the determined duration of the first time period; and the estimated proportion of the first period that precedes or succeeds the alteration of the electrical wiring connection.

In an example, the reference set of associations may be a historic set of associations between the PDU outlets and the electrical equipment units indicative of the electrical wiring connection configuration during a second time period that precedes the first time period. For example, the second time period may be a non-overlapping period of time series data that immediately precedes the first time period.

Optionally, the received PDU data further comprises time series data indicative of power usage of each of the PDU outlets during the second time period. The received activity data may further comprise time series data indicative of one or more activity metrics for each of the electrical equipment units during the second time period. In an example, detecting the event may further comprise determining the reference set of associations based on the received PDU data and activity data relating to the second time period.

In an example, estimating the alteration point further comprises iteratively adjusting the estimated alteration point by: determining a respective association relating to the altered electrical wiring connection during: a third period preceding the previously estimated alteration point; and/or a fourth period succeeding the previously estimated alteration point; based on the received PDU data and activity data; and applying a function for adjusting the previously estimated alteration point based on a comparison of the determined association to the respective association determined during a previous iteration.

Optionally, the function is configured to perform at least one of the following: increase the previously estimated alteration point if the determined association for the fourth period does not match the respective association determined during the previous iteration; reduce the previously estimated alteration point if the determined association for the third period does not match the respective association determined during the previous iteration; and/or reduce the previously estimated alteration point if the determined association for the fourth period matches the respective association determined during the previous iteration and the determined association for the third period does not match the respective association determined during the previous iteration.

Optionally, during each iteration, adjusting the estimated alteration point may further comprise: determining a confidence score associated with each determined association; and applying a function for adjusting the previously estimated alteration point based on a comparison of the determined confidence score, or a total confidence score, for the current iteration to the respective confidence score, or total confidence score, determined during a previous iteration.

Optionally, the function is configured to perform at least one of the following: adjust the alteration point in the manner of the previous iteration if the determined confidence score, or total confidence score, increases relative to the previous iteration; and/or adjust the alteration point in an opposite manner to the previous iteration if the determined confidence score, or total confidence score, reduces relative to the previous iteration. In an example, the estimated alteration point may be adjusted until the estimated alteration point is identical for successive iterations, or until a difference between the estimated alteration point for successive iterations is less than a threshold.

The third time period may, for example, start during the second time period. Optionally, the third time period may start at a start point of the second time period. Alternatively, the third time period may, for example, start during the first time period. Optionally, the third time period may start at a start point of the first time period. The fourth time period may, for example, ends during the first time period. Optionally, the fourth time period may end at an end point of the first time period.

In an example, successive non-overlapping periods of the received PDU data and activity data are analysed for event detection. The duration of each period may be determined by an analysis frequency. The method may further comprise adjusting the analysis frequency based on the estimated alteration point.

Optionally, the analysis frequency is adjusted based on the estimated alteration point and one or more historic alteration points indicative of respective historic electrical wiring connection alterations.

Optionally, adjusting the analysis frequency comprises determining respective interval periods between successive alteration points and modelling the interval periods as a function. For example, the function may be a probability distribution of the interval periods. In an example, the function may be an exponential distribution.

Optionally, the analysis frequency is determined based on the function. The analysis frequency may, for example, be determined based on the mean value of the function.

Optionally, a sampling rate of the time series data is determined as a function of the analysis frequency. For example, the sampling rate may be determined as a scalar function of a time period of the analysis frequency.

Optionally, determining the first set of associations between the PDU outlets and the electrical equipment units comprises: for each of the electrical equipment units, estimating a model that describes the activity of the respective electrical equipment unit as a function of the power usage of each of the PDU outlets; and, selecting, based on the estimated model, which of the PDU outlets are associated with the respective electrical equipment unit.

Optionally, determining the first set of associations between the PDU outlets and the electrical equipment units comprises: for each of the PDU outlets, estimating a model that describes the power usage of the respective PDU outlet as a function of the activity of each of the electrical equipment units; and, selecting, based on the estimated model, which of electrical equipment units are associated with the respective PDU outlet.

In an example, determining the first set of associations between the PDUs and the electrical equipment units comprises: calculating a distance metric between the power usage of each PDU outlet and the one or more activity metrics of each electrical equipment unit; and, determining, based on the calculated distance metrics, which of the PDU outlets are associated with each of the respective electrical equipment units.

Optionally, the method further comprises analysing the determined first set of associations against one or more defined constraints of the electrical wiring configuration to be satisfied, and outputting a remedial action if the determined first set of associations do not satisfy each of the constraints.

Optionally, the electrical power system is a data centre electrical power system. The one or more of the electrical equipment units may, for example, be server machines.

Optionally, the one or more activity metrics of each electrical equipment unit include one or more of: central processing unit (CPU) utilisation of the electrical equipment unit; memory utilisation of the electrical equipment unit; a number of bytes transferred in input/output operations generated by a process of the electrical equipment unit; disk accesses per second; and, graphics processing unit (GPU) activity of the electrical equipment unit.

According to another aspect of the disclosure there is provided a non-transitory, computer-readable storage medium storing instructions thereon that when executed by a processor cause the processor to perform a method as described in a previous aspect of the disclosure.

According to a further aspect of the disclosure there is provided a controller for monitoring an electrical power system comprising a plurality of power distribution units (PDUs) and a plurality of electrical equipment units to be provided with electrical power. The controller comprises one or more processors configured to: receive PDU data comprising time series data indicative of power usage of each of the PDU outlets during a first time period; receive activity data comprising time series data indicative of one or more activity metrics for each of the electrical equipment units during the first time period; detect an event indicative of a change of an electrical wiring connection configuration between the outlets of the PDUs and the electrical equipment units during the first time period, the event being detected by: determining a first set of associations between the PDU outlets and the electrical equipment units, indicative of the electrical wiring connection configuration during the first time period, based on the received PDU data and activity data; and comparing the first set of associations to a reference set of associations to identify an altered association indicative of an altered electrical wiring connection between a respective pair of the PDU outlets and electrical equipment units during the first time period; and upon detecting the event, estimate an alteration point of the electrical wiring connection configuration based, at least in part, on: a determined confidence score relating to the altered association; and one or more end points of the first time period.

It will be appreciated that preferred and/or optional features of each aspect of the disclosure may be incorporated alone or in appropriate combination in the other aspects of the disclosure also.

### BRIEF DESCRIPTION OF THE DRAWINGS

Examples of the disclosure will now be described with reference to the accompanying drawings, in which:

FIG. 1 schematically illustrates an electrical power system of a data centre in accordance with an example of the disclosure;

FIG. 2 shows the steps of a method for monitoring the electrical power system of FIG. 1, in accordance with an example of the disclosure;

FIG. 3 shows sub-steps for event detection in the method shown in FIG. 2, in accordance with an example of the disclosure;

FIG. 4 shows sub-steps of the method of event detection shown in FIG. 3, in accordance with an example of the disclosure;

FIG. 5 shows sub-steps for estimating a point of alteration in the method shown in FIG. 4, in accordance with an example of the disclosure; and

FIG. 6 shows sub-steps for estimating the alteration point in the method shown in FIG. 4, in accordance with another example of the disclosure; and

FIG. 7 shows sub-steps for adjusting an analysis frequency in the method shown in FIG. 2, in accordance with an example of the disclosure.

### DETAILED DESCRIPTION

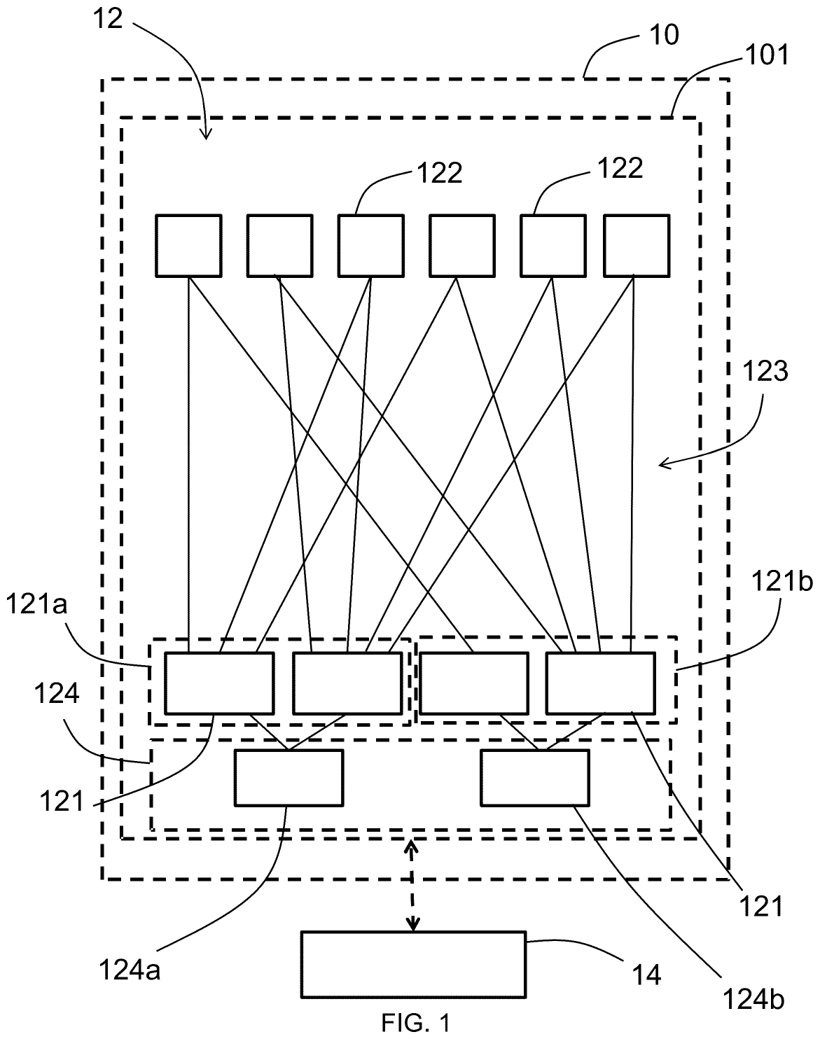

FIG. 1 is a schematic illustration of a data centre 10 that is used to house computer systems and associated components. The data centre 10 may be in the form of a building, or a dedicated space within a building, for instance.

FIG. 1 schematically illustrates an electrical power system 12 in which electrical power is supplied to systems and components in the data centre 10. The electrical power system 12 includes a plurality of power distribution units (PDUs) 121 in the form of devices that distribute power from an input to a plurality of outlets of each PDU 121. PDUs are typically used for the distribution of power to equipment such as racks of computers and/or networking equipment in a data centre. The input of each PDU 121 may receive power from any suitable power source 124, e.g. an Uninterruptible Power Supply (UPS), (backup) generator or other utility power source. Different ones of the PDUs 121 may receive power from different power sources 124. For instance, a first set 121a of the PDUs 121 may receive power from a first UPS 124a, and a second set 121b of the PDUs 121 may receive power from a second UPS 124b, different from the first UPS 124a.

The electrical power system 12 includes a plurality of electrical equipment units or components 122 that need to be provided with electrical power to operate or function. In the described example, the PDUs 121 may provide power to electrical equipment located in a server room or space 101 of the data centre 10. The electrical equipment units 122 in the server room 101 may primarily include server machines (or, simply, servers) that provide services, e.g. processing or saving/storage services, to various client stations, e.g. computers. The electrical equipment units 122 may also include other server room equipment that requires electrical power, such as peripheral devices or hardware.

The PDUs 121 supply electrical power to the servers 122 via physical links 123 therebetween. In particular, the links are in the form of electrical wires 123 that each connect an outlet of one of the PDUs 121 to one of the servers 122. As is illustrated in FIG. 1, each server 122 may be connected to more than one of the PDUs 121. In the context of a data centre, this provides redundancy in the electrical power system as a failure of one PDU does not necessarily mean that operation of an associated server stops, thereby guarding against unplanned downtime of service-critical equipment.

The particular wiring configuration of the electrical power system 12—i.e. which PDU outlets 121 are connected via the wires 123 to which servers 122—may change relatively frequently over time. In a data centre, servers and associated equipment may be swapped out of commission relatively regularly for maintenance or upgrade, e.g. a particular power line may be shut down for a period. MAC (moves, adds, changes) operations may be performed to install, relocate and/or upgrade various pieces of electrical equipment such as servers.

To monitor the mapping of the electrical wiring connections 123 between the outlets of the PDUs 121 and servers 122 manually would be expensive, time consuming, and prone to errors. Furthermore, when performed manually, updates to the mapping may be performed relatively infrequently, meaning that a relatively long time may pass between a change in the wiring configuration occurring, and this change being reflected in the records.

Although the electrical power system is described in the context of providing power to equipment in a data centre, it will be appreciated that the described electrical power system may be used in different contexts where PDUs provide electrical power to various electrical equipment units and components, e.g. in a home or office context, at a manufacturing site, etc.

FIG. 1 also includes a system or controller 14 for monitoring the electrical power system 12. In particular, the system 14 is provided for determining the configuration of the physical wiring or links 123 between the outlets of the PDUs 121 and the servers 122 and detecting changes of said configuration, as will be discussed in greater detail below. The controller 14 includes an input configured to receive data indicative of the operation of the electrical power system 12, for instance data from the PDUs 121, the servers 122, and/or another source, e.g. a storage device, that stores data indicative of the operation of the electrical power system 12. The controller 14 includes an output that may transmit alerts or control signals based on the determined wiring configuration and/or detected changes.

The controller 14 may be in the form of, or include, any suitable computing device, for instance one or more functional units or modules implemented on one or more computer processors. Such functional units may be provided by suitable software running on any suitable computing substrate using conventional or customer processors and memory. The one or more functional units may use a common computing substrate (for example, they may run on the same server) or separate substrates, or one or both may themselves be distributed between multiple computing devices. A computer memory may store instructions for performing the methods to be performed by the controller 14, and the processor(s) may execute the stored instructions to perform the methods.

Although indicated as being separate from the electrical power system 12 in the illustrated example, the system or controller 14 may be regarded as being part of the electrical power system 12 in different examples. The controller may be located in any suitable location. For instance, the controller may be in the vicinity of one or more other components of the electrical power system, e.g. in the server room 101 with the server machines of the data centre 10, or in a different location within the data centre 10. Alternatively, the controller may be remote from other components of the electrical power system, and/or remote from the data centre. Indeed, in some examples the controller may be regarded as one of the electrical equipment units that is supplied with power by the PDUs 121, and monitors itself as part of the method described below to automatically determine and monitor a wiring topology between the PDU outlets and electrical equipment units.

The present disclosure is advantageous in that it provides for automatic determination and monitoring of a configuration or topology of the physical links or wiring connections between outlets of PDUs of an electrical power system and electrical equipment units to which the PDUs provide electrical power, e.g. server machines in a data centre. In particular, the present disclosure is advantageous in that the automatic monitoring allows for changes or alterations in the wiring configuration—which may occur relatively frequently—to be identified in real time, quasi real time, or at any other desired frequency. Furthermore, the present disclosure is advantageous in that the alteration point can be accurately identified, providing additional information relating to the electrical power system 12. For example, the alteration point can be used to identify an operator responsible for the change, or to associate the change with subsequent power distribution changes.

This means that action in response to identified changes in the configuration may be performed in a timely manner. For instance, in the case of a security breach where a server is disconnected from the power supply, the breach is detected immediately, meaning that action can be taken quickly to contain the breach. As another example, in a case where one or more of the electrical equipment units have unplanned downtime, then the associated PDUs can be identified immediately, and replaced or repaired if necessary, thereby minimising the unplanned downtime.

The automatic monitoring of the present disclosure also provides an inexpensive and accurate determination of the wiring configuration, and removes the risk of errors that occur, and the expense involved, when such tasks are performed manually.

The disclosure achieves these benefits by determining a mapping between outlets of the PDUs and the electrical equipment units, e.g. servers, representing the physical links between the PDU outlets and the servers. In particular, the mapping is determined based on analysing the power usage of each of the PDU outlets in conjunction with the (processing) activity of the servers in order to determine correlations or pattens indicative of physical wiring connections between particular ones of the PDU outlets and particular ones of the servers. This is described in greater detail below. Beneficially, the disclosure uses data that is readily available in order to automatically map the wiring configuration.

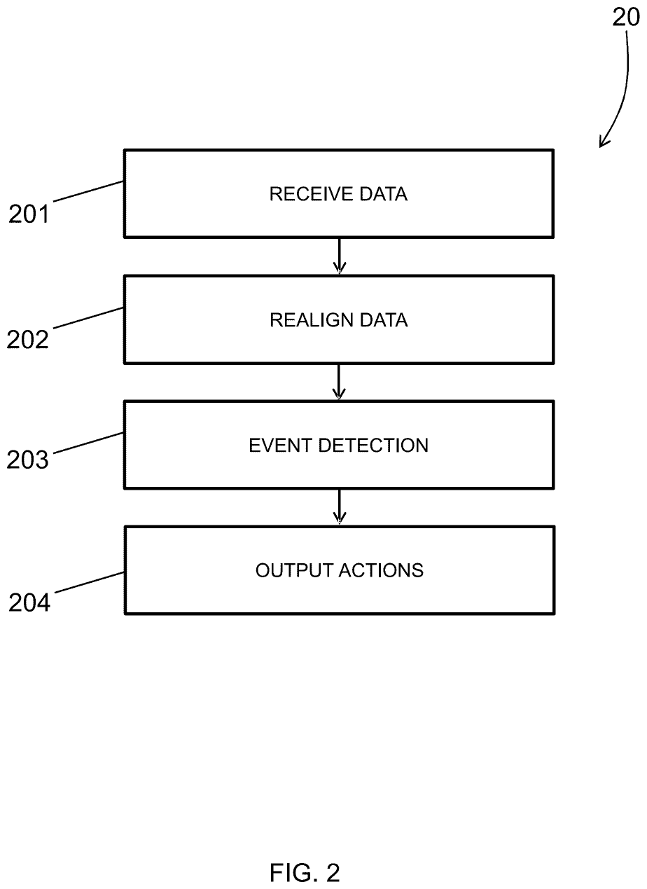

FIG. 2 shows steps of a method 20 performed by the system or controller 14 to determine and monitor a configuration of electrical wiring connections 123 between power outlets of the PDUs 121 and the electrical equipment units 122, e.g. servers and/or other server room equipment.

At step 201, the method 20 involves receiving PDU data indicative of power usage of each of the PDU outlets over time. In particular, the PDU data is received at the input of the controller 14. The PDU data may be in the form of time series data indicative of power usage of the PDU outlets over a defined historical time period, i.e. forming historical time series data in the form of a power consumption signature indicative of temporal power consumption of each PDU outlet. The time series data may be sampled at regular intervals according to a prescribed sampling rate.

The PDU data may be received or obtained directly from each of the PDU outlets (or from each of the PDUs 121). Alternatively, the PDU data may be obtained from a central platform that receives and stores power consumption data for each of the PDU outlets. The PDU data may be received by the controller 14 substantially continuously, meaning power consumption data is received in real time or quasi real time, or the PDU data may be received by the controller 14 at regular intervals with data covering a prescribed period of operation.

Also at step 201, the method 20 involves receiving activity or performance data indicative of one or more activity or performance metrics for each of the electrical equipment units 122, e.g. servers, over time. Similarly to the PDU data above, the activity data is received at the input of the controller 14. The activity data may be in the form of time series data indicative of one or more measures of server activity or performance over a defined historical time period, i.e. forming historical time series data in the form of a server activity signature indicative of temporal server activity or performance of each server 122. The time series data may be sampled at regular intervals according to a prescribed sampling rate.

The activity data may be received or obtained from each server 122 directly, for instance via standard monitoring interfaces commonly available on servers, e.g. VMware, vCenter, Windows Sysinternals, SolarWinds IT monitoring software, HPE OneView, etc. That is, the activity data may be retrieved from each server 122 by connecting to a management server or special API (application programming interface) on each server. The activity data may be received from a (PMS) platform management system for the servers.

The activity data may include any suitable data indicative of activity or performance of each server 122 over time. For instance, the activity data may include processor usage (central processing unit (CPU) percentage), memory usage, bytes read/written on the disk (e.g. disk access per second), bytes sent/received on a network interface, graphics processing unit (GPU) activity of the server, etc.

At step 202, the method 20 may optionally involve realigning the received PDU and activity time series data so that samples of the PDU data and activity data relate to the same time frame. In particular, a sampling period of received data may not be constant over time. For instance, even if a sampling period should be five seconds, then in practice it may actually be between four and six seconds. Each server may also have a different sampling rate and/or be sampled at different instants, e.g. a first server is sampled at 0, 5, 10, . . . seconds, whereas a second server is sampled at 2, 12, 22, . . . seconds. The received data may therefore be manipulated to have the same sampling period and same sampling instances. This may be performed by interpolation, e.g. linear interpolation, of the received data.

In one example, the data realignment may involve up-sampling the received PDU data and/or the activity data, and interpolating the up-sampled data to a defined sampling period. The up-sampled, interpolated data may then be down-sampled to a desired sampling period (typically the same sampling period as the original data), e.g. one second, with samples of the PDU data and activity data relating to the same time steps, i.e. the resulting data has sampling instants that are common across the PDU outlets and servers. The down-sampling means that desired data is retained, while the remaining data discarded. This data realignment may beneficially allow for more accurate analysis and comparison of PDU data and server data to identify patterns and associations in the following steps.

At step 203, the method 20 involves detecting an event indicative of a change of an electrical wiring connection configuration between the PDU outlets and the electrical equipment units 122. The method steps executed to detect such events may be scheduled at regular intervals using the data generated in the intervening time series. In other words, the method 20 may involve analysing successive non-overlapping intervals or periods of the received PDU data and activity data, according to a prescribed analysis frequency.

Accordingly, in step 203, the method 20 involves analysing a first time period (between time T1 and T2) to detect any events that are indicative of a change or alteration of the electrical wiring connection configuration. The first time period typically corresponds to a most recent time period, in this context, as the analysis is performed on successive intervals.

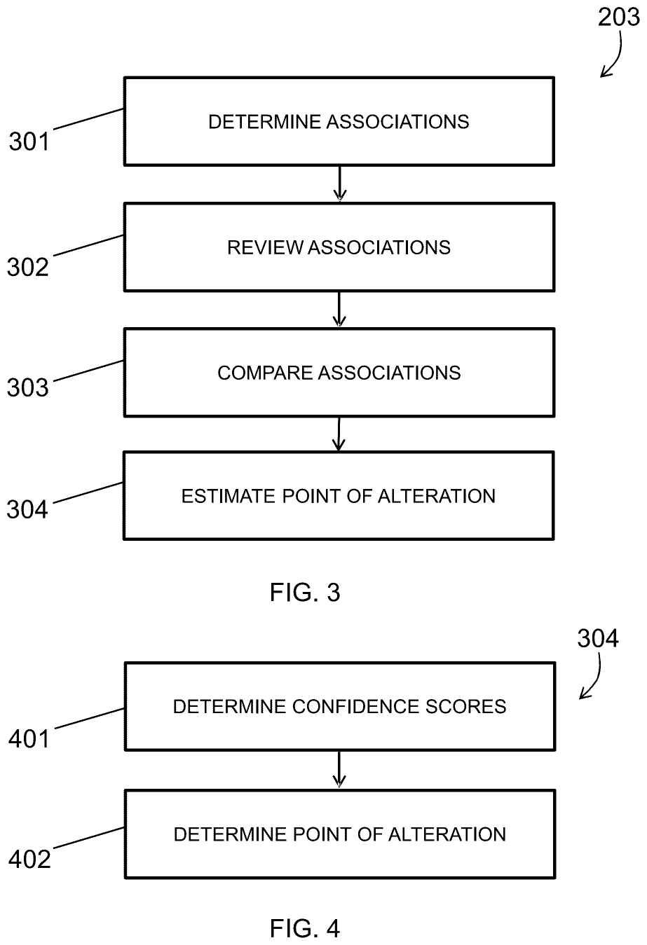

In order to detect such an event, the method 20 involves sub-steps 301 to 305, as shown in FIG. 3.

In sub-step 301, the method 20 involves determining a first set of associations between the PDU outlets 121 and the electrical equipment units 122 based on the PDU data and the activity data relating to the first time period (i.e. between T1 and T2).

The first set of associations determined in this manner are indicative of the electrical wiring connection configuration between the PDU outlets and the electrical equipment units 122 during the first time period and may be determined according to one or more methods, as shall be described in more detail below.

In one example, the associations may be determined or inferred for each server (or other electrical equipment unit) 122 by estimating a model that describes the activity of the respective server 122 during the first time period as a function of the power usage of each of the PDU outlets. The estimated model may then be used to determine which of the PDU outlets are associated with the respective server 122. In different examples, a model that describes the power usage of a respective PDU outlet as a function of the activity of the servers 122 during the analysed time period may be estimated, and then estimated model may then be used to determine which of the servers 122 are associated with the respective PDU outlet.

In more detail, consider a first one of the servers 122. The activity data, e.g. time series for the analysed period between T1 and T2, for said server 122 is extracted, as well as the power usage data for each of the PDU outlets. A model is then fitted to predict or estimate server activity using the power signature time series of each of the PDUs 121. For instance, the fitted model may be a linear model of the form:

$$s = {a}_{0} + {a}_{1} {p}_{1} + {a}_{2} {p}_{2} + {a}_{3} {p}_{3} + …$$

where s is the server 122 under consideration, p₁, p₂, p₃, . . . are the outlets of the PDUs 121 of the system 12, and a₁, a₂, a₃, . . . are coefficients representing a proportion of the activity on the server 122 under consideration which relates to the power consumption of the respective PDU outlet. a₀ may be regarded as an intercept term which represents a baseline level of activity of the server 122 under consideration that is not explained by power consumption of any of the PDU outlets.

It is assumed to be highly unlikely that increased power consumption at a PDU outlet corresponds to a decrease in server activity. As such, a constraint may be imposed that the coefficients are taken to be non-negative values, i.e. a₀, a₁, a₂, . . . ≥0.

Once the model has been fitted for the server 122 under consideration, a step is performed to discard those PDU outlets that are unrelated to the respective server 122 from the model. This may be referred to as a feature selection step. In particular, the feature selection step examines or analyses the inferred coefficients in the estimated model and, specifically, the strength of the relationship between the time series for each of the PDU outlets and the server 122. PDU outlets whose inferred coefficients are deemed not to differ significantly from zero are discarded, and the remaining PDU outlets are deemed to be connected to the server 122 under consideration.

The feature selection step may be approached in a stepwise manner. For instance, one of the PDU outlets may be considered for removal from the estimated model. A comparison of model metrics with and without said one of the PDU outlets may be performed. For instance, this may involve estimating a further model in the absence of the data associated with the PDU outlet being considered for removal, and comparing the model and further model. If there is no statistically significant degradation of performance of the server 122 under consideration, then it may be assumed that said one PDU outlet is not connected to the server 122, and said one PDU outlet is removed from the model. Otherwise, said one PDU outlet is retained in the model. This process may be repeated for each of the PDU outlets. A linear regression approach may be utilised to perform the feature selection step.

Furthermore, a bootstrap approach may be used to improve the accuracy of the feature selection. In particular, the time series data for the first time period (T1 to T2) may be broken into smaller subsections of data, and then joined together in order to minimise the effect of unusual instances in the data when estimating the model.

The above steps are repeated for each one of the servers 122 in turn until it has been inferred which of the PDU outlets are associated with, and therefore connected to, which of the servers 122.

Although the steps of estimating a (linear) model and performing feature selection in the above are described as separate steps with feature selection following model estimation, these steps may alternatively be performed simultaneously. In particular, this may be performed using an elastic net regularisation algorithm. As is known to the skilled person, the elastic net is a regularised regression method that linearly combines penalties of lasso and ridge methods, also known to the skilled person. The elastic net algorithm is described, for instance, in ‘Regularization and Variable Selection via the Elastic Net’, Zou et al., J. R. Statist. Soc. B (2005), 67, Part 2, pp. 301-320. The lasso (least absolute shrinkage and selection operator) method or algorithm is described, for instance, in ‘Regression shrinkage and selection via the lasso’, Tibshirani, J. R. Statist. Soc. B (1996), 58, No. 1, pp. 267-288. The ridge regression algorithm is described, for instance, in ‘Ridge Regression: Biased Estimation for Nonorthogonal Problems’, Hoerl et al., Technometrics (1970), Vol. 12, No. 1, pp. 55-67.

As mentioned, the elastic net algorithm is a combination of the lasso model and the ridge regression model. In both cases, these models aim to fit a linear model between an outcome—in this case, the server time series for the analysed period (T1 to T2)—and predictors—in this case, the PDU time series for the analysed period (T1 to T2)—while aiming to minimise the complexity of the resulting model. In this context, ‘complexity’ refers to the number of variables used in the model. The lasso model achieves this by discarding predictors by setting the value of their coefficient to zero, while ridge regression achieves this by shrinking the coefficients towards zero. In both cases, the coefficients can be estimated using coordinate descent, which aims to minimise a loss function that penalises for the complexity of the model.

Used in isolation, the lasso model could potentially discard a PDU time series that is highly correlated with another of the PDU time series, e.g. where power use is balanced across two PDU outlets. Also, the use of ridge regression in isolation would fail to discard any of the PDU outlets. The elastic net algorithm allows for the combination of these approaches, in particular allowing for irrelevant PDU outlets to be discarded as such, while relevant, but highly correlated, PDU outlets are retained.

In further modifications of the example in which a model is estimated, the model may be a nonlinear model rather than a linear model. For instance, a random forest may be used, which can also simultaneously infer or estimate a relationship between a server and the PDU outlets, while discarding extraneous PDU outlets.

Once a model has been estimated for each server, i.e. once the associations between each server and the PDU outlets has been inferred, the determined associations for each sever may be updated in a repository, memory, or other data storage, which may be part of the controller or system 14 or separate therefrom, of server-PDU associations.

In another example, the step of determining the associations between the PDU outlets and the servers 122 (sub-step 301) may be performed based on calculated distance metrics. In particular, the distances between the power usage or consumption time series of each PDU outlet and the activity or performance metric time series of each server 122 is calculated for the analysed period (T1 to T2). The calculated distances are measures of similarity, i.e. a correlation between two time series for the analysed period. The greater the distance, the less similar two time series are. On the other hand, lesser distances indicate greater similarity between the time series signals.

The distance metrics may be calculated using any suitable method, for instance a mean square error, with a correlation coefficient (e.g. Pearson correlation coefficient, Kendall coefficient, Spearman coefficient, etc.) as a measure of a linear correlation between two sets of data, i.e. two time series. Indeed, the distances between two time series may be calculated in different ways, such as: the multiplicative inverse of the correlation; using a Matrix Profile algorithm, which is known to the skilled person, and is described for instance in ‘Matrix Profile XII: MPdist: A Novel Time Series Distance Measure to Allow Data Mining in More Challenging Scenarios’, Gharghabi et al., 2018 IEEE International Conference on Data Mining, pp. 965-970; computing the structural similarity index measure (SSIM), which is known to the skilled person, and is described for instance in ‘Image Quality Assessment: From Error Visibility to Structural Similarity’, Wang et al., IEEE Transactions on Image Processing (2004), Vol. 13, No. 4, pp. 600-612; dynamic time warping; transform-based similarity methods, including Discrete Fourier Transform (DFT) or Discrete Wavelet Transform (DWT).

Once all of the distances between pairs of time series have been calculated, then PDU outlets are assigned to servers 122 so that the sum of distances between the two assigned time series, across all of the assignments, is minimised. That is, the sum of all distances between chosen couples/pairs of time series (or other form of the received data) is minimised. This is referred to as the linear sum assignment problem, as is known to the skilled person, and it can be solved, for instance, as described in ‘On Implementing 2D Rectangular Assignment Algorithms’ Crouse, IEEE Transactions on Aerospace and Electronic Systems (2016), Vol. 52, No. 4, pp. 1679-1696.

In the present context, each server machine 122 may be required to have redundant power supplies. As such, multiple PDU outlets may be associated to each server. One hypothesis for the linear sum assignment problem may therefore be that there are two power supplies (PDU outlets) per server, and the problem is solved to minimise the sum of distances based on this constraint or assumption. The resulting/determined assignments or associations are stored in a repository or data store (part of, or separate from, the controller 14). Similarly to above, the process of determining assignments or associations may be scheduled to be repeated at regular intervals using the data generated in the intervening timestamps. The set of determined associations together constitute the determined configuration of the wiring connections between the PDU outlets and servers 122.

In sub-step 302, the method 20 may optionally involve reviewing the server-PDU associations determined in the previous step. In one example, this may involve reviewing the determined electrical wiring configuration against one or more defined constraints to be satisfied by the electrical wiring configuration. These constraints may for instance include that a particular server 122 needs to be connected to a specific set of PDUs 121 or located in a specific rack (of PDUs 121), and/or that each server 122 (or a certain subset of servers 122) needs to be connected to at least two different PDUs 121 (for redundancy capability). The constraints may additionally or alternatively include that the PDUs 121 must have at most a predefined number of servers 122 connected thereto, for instance because of power limits of the power source 124 that the PDUs 121 are connected to. Such a review against constraints may be performed irrespective of how the server-PDU associations are performed in step 203, but may particularly be used in the example in which a model is estimated to determine the associations.

In sub-step 303, the method 20 involves comparing the first set of server-PDU associations (determined for the first time period) to a reference set of server-PDU associations to detect an altered association. In examples, the reference set of server-PDU associations may be a historic set of associations between the PDU outlets and the electrical equipment units, indicative of the electrical wiring connection configuration during a second time period. For example, the second time period may immediately precede the first time period and extend between the time T0 to T1.

In particular, sub-step 303 may involve comparing a first set or list of associations, determined in step 301 (for a most recent analysed time period—T1 to T2), with a second list or set of server-PDU associations determined for a preceding period (T0 to T1). The second set of associations may be determined for the purposes of the current analysis, i.e. during sub-step 303, or generated during a previous iteration or run of the process and retrieved from a memory or data store to perform the comparison. In each case, the second set of associations may have been determined substantially as described in step 301 based on the received PDU data and activity relating to the second time period, i.e. the preceding time period, T0 to T1.

The comparison step aims to identify differences between the current and previous sets of associations to identify changes or alterations that have occurred to the wiring configuration.

One way in which this may be performed is by first identifying associations that are present in the first set of associations (i.e. the current set), but were not present previously, i.e. not present in the second set of associations. For instance, a first element (association) may be picked from the current set of associations. If this element is in the previous set, then the next element of the current set is considered. If the first element is not in the previous set, then it may be determined whether such a change or alteration is expected. For instance, a particular server may be tagged prior to the determination of the current set of associations to indicate that it is about to be moved, added, etc. In this case, the change may be regarded as being expected. On the other hand, if no such tag or other information is available, then the change may be regarded as unexpected, and the particular element may be marked as such. This is repeated for each element (i.e. each entry or row of the current set).

The above steps of considering each element of the new set of associations may be followed by considering each element of the previous set of associations to identify associations that were present previously, but have now disappeared, i.e. they do not appear in the current set. Again, where a change is identified from the previous set to the new set, a check may be performed to determine whether the change is expected, e.g. information is available to indicate that a particular server was about to be removed from the system prior to determining the current list of associations.

Such analysis of comparing current and previous sets of associations may be performed irrespective of how the server-PDU associations are performed in step 301, but may particularly be used in the example in which the associations are determined based on minimising distance metrics between the time series. In some examples, a timestamped log of previous association lists may be stored for further analysis, e.g. to track how changes in the topology may impact the overall efficiency of the system.

If the first and second sets of associations match, the controller 14 may determine that no change in the electrical wiring configuration has occurred between the two periods and, upon receiving the next interval of server/PDU data, the method may return to step 201 to repeat the analysis for a subsequent period.

In this respect, it shall be appreciated that the analysis frequency is typically set such that each analysed period includes one event, i.e. one change in the electrical wiring configuration. However, due to the variety of reasons for changes to the electrical wiring, it is possible that no changes may occur during the analysed period.

When an altered association is detected, in sub-step 303, the altered association is indicative of a changed electrical wiring connection 123 between a respective pair of the PDU outlets and electrical equipment units 122 during the first time period. Hence, if the controller 14 detects an altered association, i.e. a change in the electrical wiring configuration between the two periods, the method 20 further involves sub-step 304 for estimating the alteration point according to one or more methods.

In an example, the method 20 includes sub-steps 401 and 402 for estimating the alteration point, as shown in FIG. 4.

In sub-step 401, the method 20 involves determining confidences scores for the first set of associations, each confidence score being indicative of the weight of evidence in support of the respective determined association. As the associations are estimated, in sub-step 301, based on data correlations and models of the system, it shall be appreciated that the relative correlation strength, for example, may reflect the confidence of the determined association.

It shall be appreciated that the confidence scores may be determined as part of, or in conjunction with, the method used in sub-step 301 for determining the first set of associations. Hence, although the steps of determining the first set of associations and the respective confidence scores are described as individual steps in the above, it shall be appreciated that the confidence scores may typically be determined simultaneously with the respective associations. Accordingly, in sub-step 401, the confidence score may be determined by recall from a memory of the controller 14, for example having been determined previously during sub-step 301. Additionally, when using the bootstrap approach to determine the associations in sub-step 301, it shall be appreciated that respective associations may be estimated for respective subsamples of the first time period, and a confidence score for the altered association may be calculated, in sub-step 401, as the proportion of such subsamples corresponding to said association.

In sub-step 402, the method 20 involves estimating an alteration point based on the determined confidence scores and one or more end points of the first time period. In particular, the confidence score may be used as an indicator of the proportion of the first time period (T1 to T2) that precedes or succeeds the alteration of the electrical wiring connection.

For example, in sub-step 402, the alteration point may be estimated by determining a duration of the first time period and estimating the alteration point based on a start point of the first time period and the estimated proportion of the first period that precedes the alteration of the electrical wiring connection.

In other words, the alteration point, T′, may be estimated according to the equation:

$${T}^{′} = T 1 + ( 1 - C 1 ) \times ( T 2 - T 1 )$$

Where T1 is the start point of the first time period, T2 is the end point of the first time period, and C1 is the confidence score determined for the altered association in the period T1 to T2.

As the association has changed during the period T1 to T2, and the confidence score C1 indicates the weight of evidence in support of the determined association during that period, the confidence score may be understood to provide an approximation of the proportion of the period that follows the altered association. It shall be appreciated that, in this example, the confidence score, C1, is a value between 0 and 1, where a value of 0 represents minimum confidence and a value of 1 represents maximum confidence. However, this is not intended to be limiting on the scope of the presently disclosed subject matter and, in other examples, the determined confidence score, C1, may be scaled and/or normalised for the purposes of the above equation (i.e. to provide a value between 0 and 1) or an alternative formula may be applied that uses the confidence score, C1, as an indicator of the proportion of the first time period (T1 to T2) that precedes or succeeds the alteration of the electrical wiring connection.

In another example, the method 20 further includes an iterative process 403 for refining the estimated alteration point, T′, determined at sub-step 402.

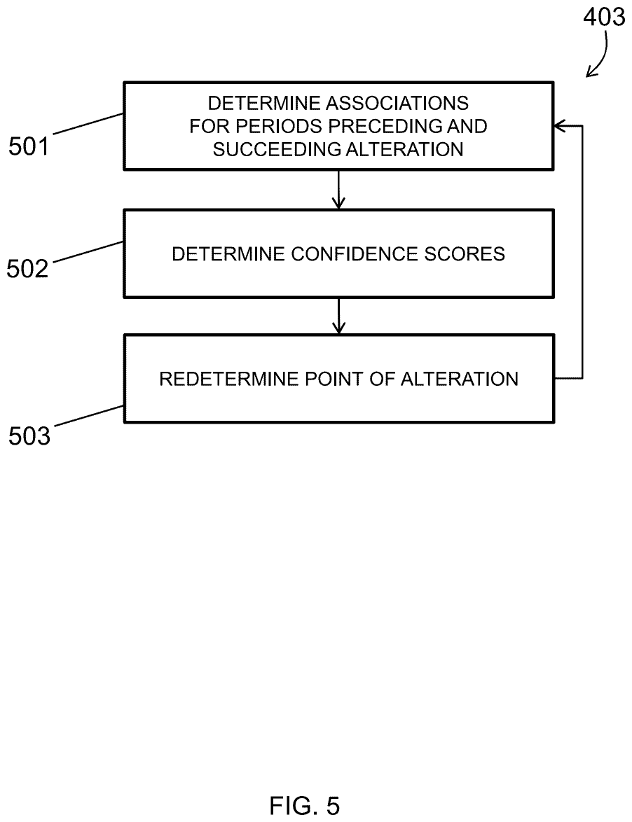

In particular, FIG. 5 shows example sub-steps 501 to 503 of an optional iterative process 403 of the method 20 for further refining the estimated alteration point, T′, following the initial estimate in sub-step 402.

In particular, during each iteration (i.e., where i=1 . . . n, and n is a positive integer), at sub-step 501, the method 20 may involve determining a respective association relating to the altered electrical wiring connection 123 during a third period that precedes the previous estimate of the alteration point, T′ᵢ₋₁, and/or a fourth period that follows or succeeds the previous estimate of the alteration point, T′ᵢ₋₁. For example, the third period may start during the second time period, e.g. at the time T0 and end at the previous estimate of the alteration point, T′ᵢ₋₁. The fourth time period may start at the previous estimate of the alteration point, T′ᵢ₋₁, and end during the first time period, e.g. at the time T2.

In this context, it shall be appreciated that, for the first iteration, the previous estimate of the alteration point, T′ᵢ₋₁, corresponds to the estimate produced in sub-step 402. However, during subsequent iterations, the previous estimate of the alteration point, T′ᵢ₋₁, corresponds to the estimate produced during the previous iteration of the method shown in FIG. 5.

In each case, the association relating to the altered electrical wiring connection 123 may be determined, substantially as described in sub-step 301, based on the received PDU data and activity data for the respective period, i.e. for the third period (T0 to T′ᵢ₋₁) or the fourth period (T′ᵢ₋₁ to T2). In this manner, the method 20 may determine a first association, A1′ᵢ, relating to the altered electrical wiring connection 123 during the third period and/or a second association, A2′ᵢ, relating to the altered electrical wiring connection 123 during the fourth period.

In this example, the method 20 further involves sub-step 502, during which the controller 14 further determines confidence scores, substantially as described in sub-step 401, for the associations determined in sub-step 501.

As previously, it shall be appreciated that the confidence scores may be determined as part of, or in conjunction with, the method used in sub-step 501 for determining the associations. Hence, although the steps of determining the associations and the respective confidence scores are described as individual steps in the above, it shall be appreciated that the confidence scores may typically be determined simultaneously with the respective associations.

It shall also be appreciated that the method 20 may determine confidence scores for each association and ignore any changes in those confidence scores where no alteration was identified for the respective electrical wiring connection 123.

In this manner, the method 20 may determine a first confidence score, C1′ᵢ, for the first association, A1′ᵢ, and/or a second confidence score, C2′ᵢ, for the second association, A2′ᵢ.

Thereafter, in sub-step 503, the method 20 applies one or more rules, schemes, and/or functions for adjusting the previously estimated alteration point, T′ᵢ₋₁, based on a comparison of the associations (A1′ᵢ, A2′ᵢ), determined in sub-step 501, and/or the confidence scores (C1′ᵢ, C2′ᵢ), determined in sub-step 502, to the respective associations (A1′ᵢ₋₁, A2′ᵢ₋₁) and/or confidence scores (C1′ᵢ₋₁, C2′ᵢ₋₁) determined previously, i.e. in sub-steps 301 and 401 or during a previous iteration (i-1).

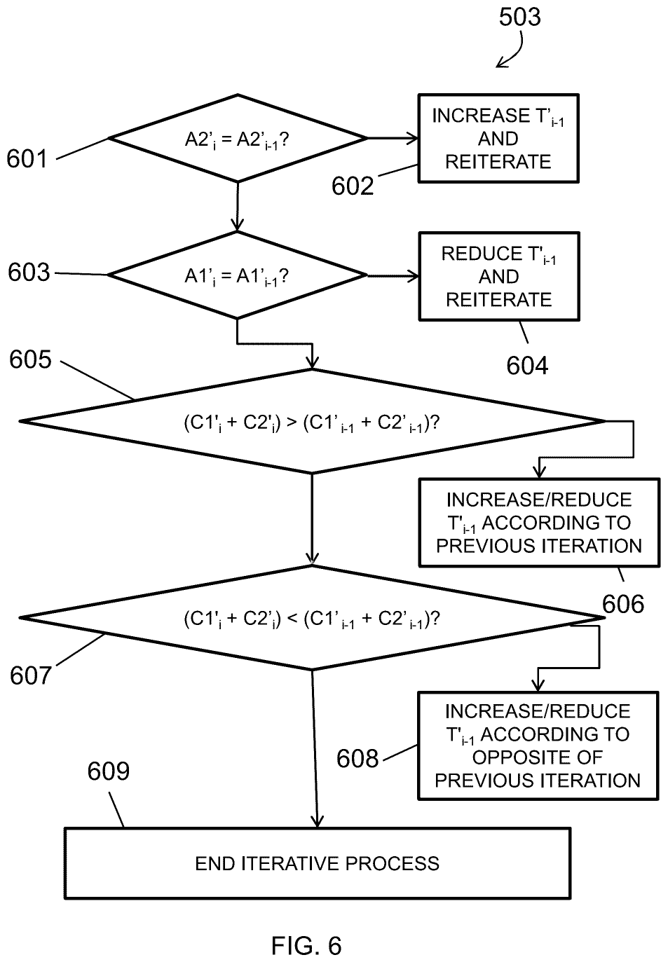

FIG. 6 shows an example set of functions/rules for adjusting the previously estimated alteration point.

In sub-step 601, the method 20 checks whether the second association, A2′ᵢ, determined in sub-step 501, is equal to the second association, A2′ᵢ₋₁, determined previously (i.e. in sub-step 301 or during a previous iteration).

If A2′ᵢ is not equal to A2′ᵢ₋₁ then the previously estimated alteration point, T′ᵢ₋₁, is increased in sub-step 602. For example, the controller 14 may apply a prescribed time increment, δT₁, to the previously estimated alteration point, T′ᵢ₋₁ to determine a new estimated alteration point, T′ᵢ.

However, if A2′ᵢ is equal to A2′ᵢ₋₁, the method 20 proceeds to check, in sub-step 603, whether the first association, A1′ᵢ, determined in sub-step 501, is equal to the first association, A1′ᵢ₋₁, determined previously.

In this case, if A1′ᵢ is not equal to A1′ᵢ₋₁, then the previously estimated alteration point, T′ᵢ₋₁, is reduced in sub-step 604. For example, the controller 14 may apply a prescribed time decrement, δT₂, to the previously estimated alteration point, T′ᵢ₋₁ to determine a new estimated alteration point, T′ᵢ.

However, if A1′ᵢ₋₁ is equal to A1′ᵢ₋₁, the method 20 proceeds to check, in sub-step 605, whether each confidence score, C1′ᵢ and C2′ᵢ, or a total confidence score, C1′ᵢ+C2′ᵢ, determined in sub-step 502 is greater than the confidence scores, C1′ᵢ₋₁ and C2′ᵢ₋₁, or total confidence score, C1′ᵢ₋₁+C2′ᵢ₋₁, determined previously, (i.e. in sub-step 401 or during a previous iteration).

If the confidence has increased, i.e. if (C1′ᵢ+C2′ᵢ)>(C1′ᵢ₋₁+C2′ᵢ₋₁), the method 20 involves adjusting the previously estimated alteration point, T′ᵢ₋₁, in sub-step 606, in the same manner as during the previous iteration (i-1). That is, if the confidence has increased, and the estimated alteration point, T′ᵢ₋₂, was increased during the previous iteration (i-1) then the estimated alteration point, T′ᵢ₋₁, is increased again, in sub-step 606, to determine the new alteration point T′ᵢ. Similarly, if the confidence has increased, and the estimated alteration point, T′ᵢ₋₂, was reduced during the previous iteration then the estimated alteration point, T′ᵢ₋₁, is reduced again in sub-step 606.

Alternatively, if it is determined, in sub-step 607, that the confidence has reduced, i.e. if (C1′ᵢ+C2′ᵢ)<(C1′ᵢ₋₁+C2′ᵢ₋₁). If the confidence has reduced, the method 20 involves adjusting the previously estimated alteration point, T′ᵢ₋₁, in an opposing manner to the previous iteration in sub-step 608. That is, if the confidence has reduced, and the estimated alteration point, T′ᵢ₋₂, was increased during the previous iteration, then the estimated alteration point, T′ᵢ₋₁, is reduced in sub-step 608 to determine the new alteration point T′ᵢ. Similarly, if the confidence has reduced, and the estimated alteration point, T′ᵢ₋₂, was reduced during the previous iteration, then the estimated alteration point, T′ᵢ₋₁, is increased in sub-step 608.

However, if the confidence remains the same during successive iterations, i.e. if (C1′ᵢ+C2′ᵢ)=(C1′ᵢ₋₁+C2′ᵢ₋₁) or the difference between the successive iterations is less than a threshold, ε, the method 20 completes the iterative process, in sub-step 609, and outputs the estimated alteration point, T′ᵢ₋₁.

In other examples, it shall be appreciated that alternative rules, schemes or functions may be used for adjusting the estimated alteration point, T′, which may, for example, involve any one or more of the sub-steps 601 to 608 described above.

In each case, the estimated alteration point, T′, and/or the altered association, may also be recorded in a memory, for example where the controller 14 stores a database of historic electric wiring connection configuration changes.

Returning to FIG. 2, having refined the estimated alteration point, T′, the method 20 may optionally involve outputting, via the controller 14, one or more actions, in step 204, in response to the results of the analysis.

In one example, when an event has been detected in step 203, one such action output in step 204 may involve adjusting the analysis frequency based on the estimated alteration point, T′. That is, adjusting the frequency with which successive intervals of the activity data and PDU data are analysed (according to the method 20).

The analysis frequency is typically set at a frequency that balances operational cost against accuracy parameters, such as event detection accuracy. A greater analysis frequency typically increases event detection accuracy at increased operational cost. Striking a balance between these two objectives is not trivial and depends on the entropy of the specific application, or the specific data centre 10 for example, in which the method 20 is deployed. For example, a data centre in which the electric wiring connection configuration changes hourly will benefit from a greater analysis frequency than a data centre in which the electric wiring connection configuration changes monthly.

Accordingly, the controller 14 may identify the precise timing of each alteration of the electrical wiring connection configuration, in sub-step 304, and use such information as a surrogate for the entropy of the connectivity model.

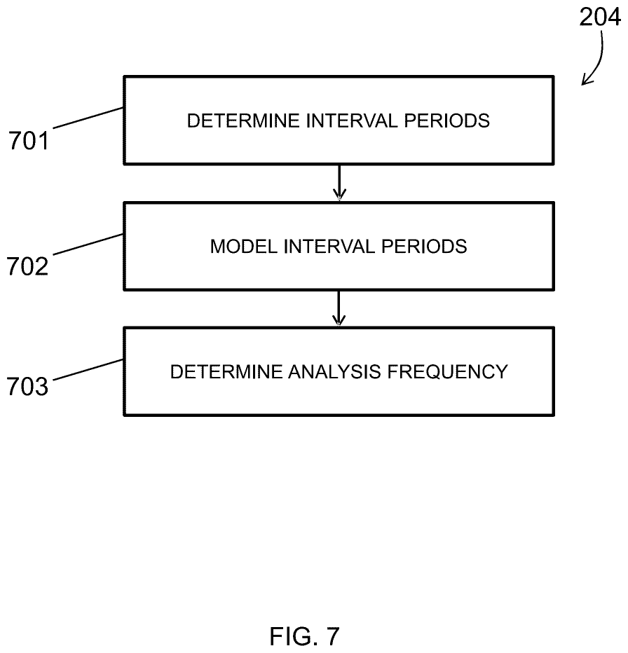

For this purpose, the method 20 may involve sub-steps 701 to 703, shown in FIG. 7, for determining the analysis frequency as one of the output actions in step 204.

In sub-step 701, the method 20 involves determining the interval periods between successive historic alteration points, including the most recent alteration point, T′, determined in sub-step 304. The interval periods may be determined irrespectively of the corresponding altered associations (i.e. irrespective of which electrical wiring connections 123 have changed), thereby taking account of each detected change of the electrical wiring connection configuration.

Thereafter, the method 20 processes the determined interval periods to identify an analysis frequency that process respective intervals of the activity and PDU data of an appropriate duration to capture one event per interval. The analysis frequency may therefore be optimised in this manner according to one or more methods.

To give an example, in sub-step 702, the method 20 involves modelling the interval periods as a function, such as probability distribution, of the time between events. For example, the interval periods may be modelled as an exponential distribution, assuming that the alterations of the electrical wiring connection configuration occur continuously and independently at a constant average rate.

In sub-step 703, the method 20 determines the analysis frequency based on the function that models the interval periods. For example, the analysis frequency may be determined based on the mean interval period of the exponential distribution determined in sub-step 702. In particular, the analysis frequency may be determined as the reciprocal of the mean interval period. The determined analysis frequency should therefore be suitable for detecting one event, i.e. on alteration of the electrical wiring connection configuration, per interval.

The determined analysis frequency is used for subsequent monitoring of the electrical system 12 according to the method 20, providing an optimised balance between the operational cost and the event detection accuracy. In this case it would be expected that one event would occur during each interval or analysis period.

In an example, the one or more actions of step 204 may further include determining a sampling rate for the PDU data and/or the activity data acquisition. For example, the controller 14 may further determine each sample rate as a function of the analysis frequency to provide the greatest event detection accuracy with the minimal sampling rate. In an example, a continuous monotonic function can be extracted to define the optimal sampling rate based on the analysis frequency. The function could be a linear function, for example, where the sample rate, R, is determined as:

$$R = K \times F$$

Where K is a predetermined constant and F is the analysis frequency. It shall be appreciated that, in other examples, other suitable methods for determining the sampling rate based on the analysis frequency may be used.

In any case, the determined sample rate, R, is then communicated to a data acquisition portion of the controller 14 and applied for the subsequent monitoring of the electrical system 12.

It shall be appreciated that the analysis frequency and/or the sampling rate may be updated in this manner following each event detection or, for example, at prescribed update frequency or after a prescribed number of detected events.

Returning to FIG. 2, in other examples, remedial actions may be output in step 204 in dependence on detecting an event in step 203, particularly where an unexpected alteration of the electrical wiring connection configuration is detected, where one or more constraints are not satisfied, and/or where one or more redundancy measures are no longer satisfied as a result of the alteration.

In one example, an action may be output if one or more of the constraints are deemed to not be satisfied. For instance, an audio and/or visual alarm (or other suitable alarm) may be generated, e.g. in the vicinity of the server room. Alternatively, or in addition, notifications may be sent to maintenance and/or system administrative personnel, for instance via email, phone notifications, sound or visual indicators in a control room for the data centre 10.

In another example, an action may be output if one or more unexpected changes are detected (at step 203) in the wiring configuration. For instance, an alert may be sent to a system administrator providing information related to the unexpected change. A possible action may be to trigger a secure erase operation of a server 122 associated with the unexpected change, if it is still accessible via the network. A further action could be to prevent access to the relevant servers, e.g. by automatically locking a door of the server room of the data store 10 in which the servers are located, thereby preventing equipment being removed from the server room. Other actions may also be performed, based on a required security level of the specific data centre under consideration. In relatively low-security cases, actions following an alert being sent to a system administrator (or other relevant personnel) may be performed only after the system administrator confirms that the alert is not a false positive, for instance. While this may increase a delay to applying security measures, it acts to avoid disruptive server downtime in case of false positives. It will be understood that these actions in response to unexpected changes may particularly be useful in the context of detecting, and acting to contain, security breaches or vandalism in a data centre, such as a malicious individual disconnecting a server from a power line, e.g. unauthorised replacement of servers or theft of servers, in a manner that changes the power topology of the system.

As mentioned above, in a specific example the determined associations between the outlets of the PDUs 121 and the servers 122 may be used to ensure that sufficient and necessary redundancy is in place for the servers 122 of the system 12, e.g. for disaster avoidance. The described method may also be used to restore redundancy to each of the servers 122, as required.

In more detail, redundancy refers to the design of a system to duplicate certain components such that failure of one of the components (e.g. such that there is disruption to normal power supply) does not impact on the operation and services of critical IT infrastructure. In the present context, a redundant power supply may be provided so that in the case of a power outage or failure, servers may continue to operate. As mentioned above, servers and/or PDUs in a data centre may be added to, moved or removed from a power distribution system relatively frequently, for instance to perform routine work on computer equipment, such as installations, relocations or upgrades. It can therefore be challenging to ensure that redundancy, e.g. power supply redundancy, is maintained in such an electrical power system.

A redundant power supply requirement or constraint may be that critical equipment must be connected to at least two different PDU outlets, and/or that the PDU outlets to which the critical equipment component is connected receive power from different power sources 124. In the present case, each of the electrical equipment units 122 are server machines. It may be that the operation of each of the servers 122 is critical such that each of the servers 122 need a redundant power supply, i.e. each of the servers 122 need to be connected to at least two of the PDU outlets 121. In different cases, it may be that only some of the servers 122 provide services that are considered to be critical, in which case only that critical subset of servers 122 may be required to have a redundant power supply. In further different cases, the plurality of electrical equipment units may provide a number of different types of equipment (e.g. peripheral devices as well as servers), in which case only a subset of the electrical equipment units may be regarded as being critical and need a redundant power supply.

When analysing the server-PDU associations at step 203 of the method 20, it may be determined whether any constraints relating to the necessary redundancy of the system 12 are satisfied. This may first involve identifying which of the electrical equipment units are regarded as critical in the sense that they need a redundant power supply. This may be performed via a look up of an equipment inventory repository, for instance. It may be that certain types of electrical equipment units, e.g. servers, are regarded as critical, whereas other types, e.g. peripheral devices, are not.

For each of the identified critical electrical equipment units, it may first be determined whether the respective unit is connected to at least two different PDU outlets. This ensures that failure of one of the connected PDU outlets does not mean operation of the critical unit is compromised. If the condition that the critical equipment unit is connected to two PDU outlets is satisfied, then it may be determined whether the respective critical equipment unit is linked to at least two different power sources 124a, 124b. That is, the different PDU outlets to which the critical electrical equipment unit is connected may be required to be provided with power from different power sources. For instance, one of connected PDUs 121 may receive power from the first power source 124a, and the other of the connected PDUs 121 may receive power from the second power source 124b. This ensures that failure of one of the power sources 124a, 124b does not mean operation of the critical equipment unit is compromised.

If it is determined that one of the critical electrical equipment units 122 does not satisfy the redundancy constraint(s), then action may be taken to restore the required redundancy to the system 12. This may involve the controller 14 identifying a PDU outlet to which the critical unit 122 can be connected to restore redundancy. A list of available PDU outlets may be obtained in the first instance, i.e. a list of PDU outlets not in use (by virtue of already being connected to an electrical equipment unit 121, for instance). Such a list may be obtained from the wiring configuration of determined associations (from step 203). From the determined associations, it is known which PDU outlets are connected to which electrical equipment units 122 and, as such, which PDU outlets have available outlets not currently in use, i.e. not currently connected to another component.

In one example, the output action at step 204 may be simply to provide an indication of which critical equipment unit 122 does not satisfy the redundancy requirement, along with the list of available PDU outlets, so that a user or operator can select which of the available PDU outlets to connect to the identified critical equipment unit 122 to restore redundancy.

Alternatively, the step of analysing the determined associations against redundancy constraints may further include selecting a particular one (or more) of the available PDU outlets, and then the output action may be to provide a specific recommendation to a user to connect the selected PDU outlet to the identified critical equipment unit 122 to restore redundancy.

The identified critical equipment unit 122 along with the list of available PDU outlets, or the specific recommendation, may be provided in any suitable manner. For instance, this could be performed via alerts sent to management software for the system 12, a text message or call to a mobile telephone, or visual alerts in a control room of the data centre 10.

The selection of a particular one of the available PDU outlets may be based on a number of different factors, and may be performed to optimise one or more aspects of the wiring configuration and system operation. A physical layout or arrangement of the various components in the data centre 10 may be stored in memory, and may be available to the controller 14. The selection of a particular available PDU outlet may be based on the relative physical proximity of different components of the system 12. For instance, in one example the particular one of the available PDU outlets (or an available outlet of the particular one of the PDUs 121) that is closest to the identified critical unit 122 may be selected, which can assist in maintaining a simple wiring configuration. In another example, the particular one of the available PDU outlets that is closest to/adjacent to another (or the other) PDU outlet that is connected to the identified critical unit 122—but, optionally, which receives power from a different power source 124—may be selected, again for reasons of configuration simplicity for instance.

The selection of a particular one of the available PDU outlets may optionally be based on a loading, at a given time, of different power sources 124 providing power to the PDUs 121. A current loading of different power sources 124 may be obtained in any suitable manner. For instance, the current loading of each power source may be inferred from the determined server-PDU associations. In an example, the selection of an available PDU outlet may be made to improve the load balancing in the system 12, e.g. the selected PDU outlet may be part of a PDU 121 that receives power from the power source 124 in the system 12 that has the lowest current loading.

The selection of a particular one of the available PDU outlets may be based on a combination of different factors, e.g. according to an optimisation algorithm that optimises across a plurality of different factors. For instance, the selected PDU outlet may be identified based on one or more of: maximising the use of adjacent PDU outlets or adjacent PDUs 121; a proximity to the electrical equipment unit in question; improved load balancing of the system 12; and, a consideration of the entire power chain for the identified PDU or PDU outlet.

Many modifications may be made to the described examples without departing from the scope of the appended claims.

1. A computer-implemented method for monitoring an electrical power system comprising a plurality of power distribution units (PDUs) and a plurality of electrical equipment units to be provided with electrical power, the method comprising:
receiving PDU data comprising time series data indicative of power usage of each of the PDU outlets during a first time period;
receiving activity data comprising time series data indicative of one or more activity metrics for each of the electrical equipment units during the first time period;
detecting an event indicative of a change of an electrical wiring connection configuration between the outlets of the PDUs and the electrical equipment units during the first time period, the event being detected by:
determining a first set of associations between the PDU outlets and the electrical equipment units, indicative of the electrical wiring connection configuration during the first time period, based on the received PDU data and activity data; and
comparing the first set of associations to a reference set of associations to identify an altered association indicative of an altered electrical wiring connection between a respective pair of the PDU outlets and electrical equipment units during the first time period; and
upon detecting the event, estimating an alteration point of the electrical wiring connection configuration based, at least in part, on:
a determined confidence score relating to the altered association; and
one or more end points of the first time period.

2. A method according to claim 1, wherein estimating the alteration point comprises estimating a proportion of the first time period that precedes or succeeds the alteration of the electrical wiring connection based on the determined confidence score.

3. A method according to claim 1, wherein the reference set of associations is a historic set of associations between the PDU outlets and the electrical equipment units indicative of the electrical wiring connection configuration during a second time period that precedes the first time period.

4. A method according to claim 3, wherein the received PDU data further comprises time series data indicative of power usage of each of the PDU outlets during the second time period;
wherein the received activity data further comprises time series data indicative of one or more activity metrics for each of the electrical equipment units during the second time period; and
wherein detecting the event further comprises determining the reference set of associations based on the received PDU data and activity data relating to the second time period.

5. A method according to claim 1, further comprising iteratively adjusting the estimated alteration point by:
determining a respective association relating to the altered electrical wiring connection during:
a third period preceding the previously estimated alteration point; and/or
a fourth period succeeding the previously estimated alteration point;
based on the received PDU data and activity data; and
applying a function for adjusting the previously estimated alteration point based on a comparison of the determined association and the respective association determined during a previous iteration.

6. A method according to claim 5, wherein the function is configured to perform at least one of the following:
increase the previously estimated alteration point if the determined association for the fourth period does not match the respective association determined during the previous iteration;
reduce the previously estimated alteration point if the determined association for the third period does not match the respective association determined during the previous iteration; and/or
reduce the previously estimated alteration point if the determined association for the fourth period matches the respective association determined during the previous iteration and the determined association for the third period does not match the respective association determined during the previous iteration.

7. A method according to claim 5, wherein, during each iteration, adjusting the estimated alteration point further comprises:
determining a confidence score associated with each determined association; and
applying a function for adjusting the previously estimated alteration point based on a comparison of the determined confidence score, or a total confidence score, for the current iteration to the respective confidence score, or total confidence score, determined during a previous iteration.

8. A method according to claim 7, wherein the function is configured to perform at least one of the following:
adjust the alteration point in the manner of the previous iteration if the determined confidence score, or total confidence score, increases relative to the previous iteration; and/or
adjust the alteration point in an opposite manner to the previous iteration if the determined confidence score, or total confidence score, reduces relative to the previous iteration.

9. A method according of claim 5, wherein:
the third time period starts during the second time period, optionally, starting at the start of the second time period;
the third time period starts during the first time period, optionally, starting at the start of the first time period; and/or
the fourth time period ends during the first time period, optionally, ending at an end point of the first time period.

10. A method according to claim 1, wherein successive non-overlapping periods of the received PDU data and activity data are analysed for event detection, the duration of each period being determined by an analysis frequency, and wherein the method further comprises adjusting the analysis frequency based on the estimated alteration point.

11. A method according to claim 10, wherein the analysis frequency is adjusted based on the estimated alteration point and one or more historic alteration points indicative of respective historic electrical wiring connection alterations.

12. A method according to claim 11, wherein adjusting the analysis frequency comprises determining respective interval periods between successive alteration points and modelling the interval periods as a function, optionally, the function is a probability distribution of the interval periods, optionally, the function is an exponential distribution.

13. A method according to claim 12, wherein the analysis frequency is determined based on the function, optionally, wherein the analysis frequency is determined based on the mean value of the function.

14. A method according to claim 10, wherein a sampling rate of the time series data is determined as a function of the analysis frequency, optionally, as a scalar function of a time period of the analysis frequency.

15. A method according to claim 1, wherein determining the first set of associations between the PDU outlets and the electrical equipment units comprises:
for each of the electrical equipment units,
estimating a model that describes the activity of the respective electrical equipment unit as a function of the power usage of each of the PDU outlets; and,
selecting, based on the estimated model, which of the PDU outlets are associated with the respective electrical equipment unit, or
for each of the PDU outlets,
estimating a model that describes the power usage of the respective PDU outlet as a function of the activity of each of the electrical equipment units; and,
selecting, based on the estimated model, which of the electrical equipment units are associated with the respective PDU outlet.

16. A method according to claim 1, wherein determining the first set of associations between the PDUs and the electrical equipment units comprises:
calculating a distance metric between the power usage of each PDU outlet and the one or more activity metrics of each electrical equipment unit; and,
determining, based on the calculated distance metrics, which of the PDU outlets are associated with each of the respective electrical equipment units.

17. A method according to claim 1, further comprising analysing the determined first set of associations against one or more defined constraints of the electrical wiring configuration to be satisfied, and outputting a remedial action if the determined first set of associations do not satisfy each of the constraints.

18. A method according to claim 1, wherein the electrical power system is a data centre electrical power system, and wherein one or more of the electrical equipment units are server machines.

19. A method according to claim 1, wherein the one or more activity metrics of each electrical equipment unit include one or more of:
central processing unit (CPU) utilisation of the electrical equipment unit;
memory utilisation of the electrical equipment unit;
a number of bytes transferred in input/output operations generated by a process of the electrical equipment unit;
disk accesses per second; and,
graphics processing unit (GPU) activity of the electrical equipment unit.

20. A non-transitory, computer-readable storage medium storing instructions thereon that when executed by a processor cause the processor to perform a method according to claim 1.

21. A controller for monitoring an electrical power system comprising a plurality of power distribution units (PDUs) and a plurality of electrical equipment units to be provided with electrical power, the controller comprising one or more processors configured to:
receive PDU data comprising time series data indicative of power usage of each of the PDU outlets during a first time period;
receive activity data comprising time series data indicative of one or more activity metrics for each of the electrical equipment units during the first time period;
detect an event indicative of a change of an electrical wiring connection configuration between the outlets of the PDUs and the electrical equipment units during the first time period, the event being detected by:
determining a first set of associations between the PDU outlets and the electrical equipment units, indicative of the electrical wiring connection configuration during the first time period, based on the received PDU data and activity data; and
comparing the first set of associations to a reference set of associations to identify an altered association indicative of an altered electrical wiring connection between a respective pair of the PDU outlets and electrical equipment units during the first time period; and
upon detecting the event, estimate an alteration point of the electrical wiring connection configuration based, at least in part, on:
a determined confidence score relating to the altered association; and
one or more end points of the first time period.
